(19) United States
(12) Patent Application Publication
(10) Pub. No.: US 2020/0172113 A1
(43) Pub. Date: Jun. 4, 2020

(54) APPARATUS AND METHOD FOR DETERMINING DRIVING TENDENCY OF DRIVER

(71) Applicants: Hyundai Motor Company, Seoul (KR); Kia Motors Corporation, Seoul (KR)

(72) Inventor: Sun Woo Kim, Seoul (KR)

(21) Appl. No.: 16/271,409

(22) Filed: Feb. 8, 2019

(30) Foreign Application Priority Data
Dec. 4, 2018 (KR) 10-2018-0154730

(51) Int. Cl. B60W 40/09; G07C 5/08; G05B 13/02; B60W 50/00; B60W 40/08

(52) U.S. Cl. CPC B60W 40/09; G07C 5/085; B60W 2040/0881; B60W 50/0098; B60W 40/08; G05B 13/0265

(57) ABSTRACT

An apparatus for determining a driving tendency of a driver is provided. The apparatus includes a sensor that obtains driving information of the driver and senses an occupant seated in a vehicle with the driver. A controller determines occupant information based on the sensed information and determines the driving tendency of the driver corresponding to the occupant information based on the driving information of the driver. Accordingly, the driving of the vehicle is adjusted by taking into account the driving tendency of the driver, which is changed depending on the occupant information.

### CROSS-REFERENCE TO RELATED APPLICATION

This application is based on and claims the benefit of priority to Korean Patent Application No. 10-2018-0154730, filed on Dec. 4, 2018, the disclosure of which is incorporated herein in its entirety by reference.

### TECHNICAL FIELD

The present disclosure relates to an apparatus and a method for determining a driving tendency of a driver, and more particularly, to an apparatus and method for determining a driving tendency of a driver by taking into account information about a specific driver and an occupant.

### BACKGROUND

In recent years, an apparatus that sets a control value of a powertrain, e.g., an optimal transmission stage, an engagement feel of transmission, and an engine torque map, which are satisfactory to customers, based on a driving tendency of a driver, a prediction of the road ahead, road congestion, and a road friction state and adjusts driving of a vehicle has been developed. Among them, the control value of the powertrain set based on the driving tendency of the driver uses a method of learning the usual driving tendency of the driver. As an example, the driving tendency of the driver is determined based on the result of learning the driving tendency while a vehicle is being driven with only a driver within the vehicle and during commuting hours on weekdays, and the control value of the powertrain is set based on the learned result. In other words, the driving tendency of the driver is learned during typical or routine driving conditions for a particular driver.

However, when the driving situation changes and the driver is operating the vehicle out of the routine (e.g., on the weekends) with additional passengers, the vehicle runs at the control value of the powertrain set according to the driving tendency of the driver, which is previously determined, and as a result, causes discomfort to occupants. In addition, when one vehicle is shared by different drivers, the vehicle is operated only based on the driving tendency of one of the driver, which is previously determined, without reflecting different driving tendencies of the multiple drivers. As a result, when the driving tendency set in the vehicle differs from the driving tendency of the driver, it causes discomfort to the driver.

### SUMMARY

The present disclosure accordingly provides an apparatus and a method for determining a driving tendency of a driver by taking into account information about a specific driver and an occupant. The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for determining a driving tendency of a driver may include a sensor configured to obtain driving information of the driver and sense an occupant seated within a vehicle with the driver and a controller configured to determine occupant information based on the sensed information and determine the driving tendency of the driver corresponding to the occupant information based on the driving information of the driver.

The sensor configured to sense the occupant information may include an occupant detection sensor (ODS) and a seat belt reminder signal (SBR) sensor. The occupant information may include that no occupant exists in the vehicle, that the occupant is an adult, and that the occupant is an infant/toddler. The controller may be configured to classify the driving information of the driver according to driver information when different drivers from each other exist.

The driver information may be identified based on communication information with a mobile terminal or driving posture setting information. The controller may be configured to classify the driving information of the driver based on the driver information of the different drivers according to the occupant information. Additionally, the controller may be configured to learn the driving information of the driver, wherein the driving information of the driver classified according to the occupant information, and determine the driving tendency of the driver corresponding to the occupant information based on the learned result.

The apparatus may further include a storage configured to store the driving information of the driver. The storage may include one or more slots in which the driving tendency of the driver, which is determined according to the occupant information, may be stored and a bank in which the one or more slots may be stored after being classified according to the driver information. The controller may be configured to set a control value of a powertrain based on the determined driving tendency of the driver.

According to another aspect of the present disclosure, a method for determining a driving tendency of a driver may include receiving driving information of the driver, identifying occupant information of an occupant seated within a vehicle with the driver, and determining the driving tendency of the driver corresponding to the occupant information based on the driving information of the driver.

The identifying of the occupant information may be performed based on information obtained by an occupant detection sensor (ODS) or a seat belt reminder signal (SBR) sensor. The occupant information may include information that no occupant exists in the vehicle, that the occupant is an adult, and that the occupant is an infant/toddler. The method may further include classifying the driving information of the driver according to driver information when different drivers from each other exist. The driver information may be identified based on communication information with a mobile terminal or driving posture setting information.

The method may further include classifying the driving information of the driver based on the driver information of the different drivers according to the occupant information. The determining of the driving tendency of the driver may include learning the driving information of the driver, wherein the driving information of the driver may be classified according to the occupant information, and determining the driving tendency of the driver corresponding to the occupant information based on the learned result. The method may further include setting a control value of a powertrain based on the determined driving tendency of the driver.

The apparatus and method for determining the driving tendency of the driver according to the exemplary embodiment of the present disclosure determine the driving tendency of the driver by taking into account the information about the driver and occupant and set the control value of the powertrain based on the driving tendency of the driver. Accordingly, the driving of the vehicle may be adjusted in consideration of the driving tendency of the driver, which is changed depending on the occupant information.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for determining a driving tendency of a driver according to an exemplary embodiment of the present disclosure;

FIG. 2 is a view illustrating a structure of storage of an apparatus for determining a driving tendency of a driver according to an exemplary embodiment of the present disclosure;

FIG. 3 is a flowchart illustrating a method for determining a driving tendency of a driver according to an exemplary embodiment of the present disclosure;

FIG. 4 is a flowchart illustrating a method for determining driver information according to an exemplary embodiment of the present disclosure;

FIG. 5 is a flowchart illustrating a method for determining occupant information according to an exemplary embodiment of the present disclosure; and

FIG. 6 is a block diagram illustrating a configuration of a computing system that executes a method for determining a driving tendency of a driver according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present disclosure will be described in detail with reference to the accompanying drawings. In the drawings, the same reference numbers will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

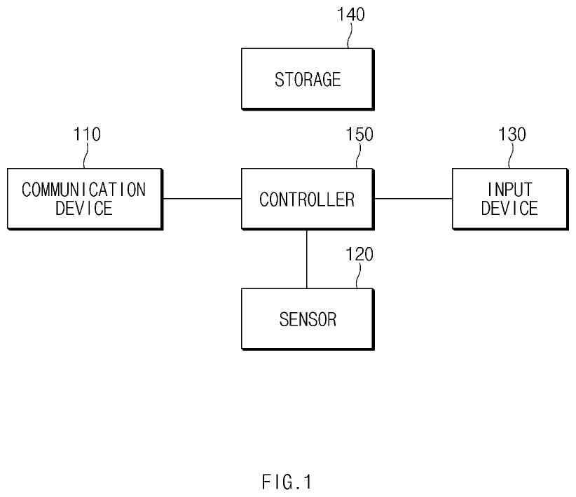

FIG. 1 is a block diagram illustrating an apparatus for determining a driving tendency of a driver according to an exemplary embodiment of the present disclosure. As shown in FIG. 1, the apparatus for determining the driving tendency of the driver according to an exemplary embodiment of the present disclosure may include a communication device 110, a sensor 120, an input device 130, a storage 140, and a controller 150.

In particular, the communication device 110 may be configured to communicate with a mobile terminal of the driver. In the present exemplary embodiment, the mobile terminal may include a smart phone, a smart pad, a notebook computer, or the like. The communication device 110 may be connected to the mobile terminal in a wired or wireless manner. When the communication device 110 is connected to the mobile terminal in the wired manner, the communication device 110 may be connected to the mobile terminal by a universal serial bus (USB) cable, and when the communication device 110 is connected to the mobile terminal in the wireless manner, the communication device 110 may be connected to the mobile terminal by a WiFi-Direct communication. According to an exemplary embodiment, the communication device 110 may be connected to the mobile terminal via a short-range wireless communication, such as a Wireless Broadband (WiBro), a World Interoperability for Microwave Access (Wimax), a Bluetooth, a Radio Frequency Identification (RFID), an Infrared Data Association (IrDA), an Ultra Wideband (UWB), or a ZigBee.

Further, the sensor 120 may be configured to obtain driving information of the driver and sense an occupant. First, the sensor 120 configured to obtain the driving information of the driver may include an accelerator pedal position sensor, a vehicle speed sensor, a transmission stage sensor, an acceleration sensor, a steering angle sensor, a brake pedal position sensor, an inter-vehicle distance sensor, or the like. The accelerator pedal position sensor may be configured to obtain or detect data that corresponds to an engagement amount of an accelerator pedal (e.g., the amount of force exerted onto the pedal by the driver). In other words, the accelerator pedal position sensor may be configured to obtain information related to a driver's acceleration intention.

The vehicle speed sensor may be configured to measure a speed of the vehicle and may be mounted on a wheel of the vehicle. The transmission stage sensor may be configured to detect a transmission stage that is currently engaged. The acceleration sensor may be configured to detect an acceleration of the vehicle. In particular, the acceleration of the vehicle may be calculated by differentiating the speed of the vehicle detected by the vehicle speed sensor. The steering angle sensor may be configured to detect a steering angle of the vehicle. In other words, the steering angle sensor may be configured to detect a direction in which the vehicle is being operated (e.g., a running direction of the vehicle).

Additionally, the brake pedal position sensor may be configured to detect whether the driver engages a brake pedal. In other words, the brake pedal position sensor may be configured to detect the driver's acceleration intention with the accelerator pedal position sensor. The inter-vehicle distance sensor may be configured to detect a distance between a driver's vehicle (e.g., a subject vehicle) and a front vehicle (e.g., a forward vehicle, preceding vehicle, etc.). For the inter-vehicle distance sensor, various sensors, such as an ultrasonic sensor or an infrared sensor, may be used. In addition, the sensor 120 configured to sense or detect the occupant within the vehicle may include an occupant detection sensor (ODS) and a seat belt reminder signal (SBR) sensor.

Particularly, the ODS may be configured to sense a weight of the occupant. The ODS may be disposed in a seat of the vehicle, a plurality of switches may be turned on or off when the seat is pressed by the weight of the occupant seated on the seat, and thus varying voltages may be output. The SBR sensor may be configured to sense whether a seat belt is fastened (e.g., engaged, in use, etc.). The SBR sensor may be disposed on a buckle of a seat belt and may be configured to output signals with different frequencies or different phase angles depending on whether the buckle is buckled or unbuckled. According to an exemplary embodiment, the SBR sensor may usually use a thin film switch, and the thin film switch may have a structure in which a conductor is printed.

The input device 130 may be configured to output an input signal that is an electrical signal corresponding to a driver's operation. The input device 130 may be configured to input driving posture setting information in response to the driver's operation. In the present exemplary embodiment, the driving posture setting information may include one or more setting information set by different drivers. The input device 130 may be implemented by at least one of a scroll wheel, a button, a knob, a touch screen, a touch pad, a lever, a track ball, a motion sensor, or a sound recognition sensor or a combination thereof. The storage 140 may be configured to store the driving information of the driver obtained by the sensor 120 and the driving posture setting information input by the input device 130.

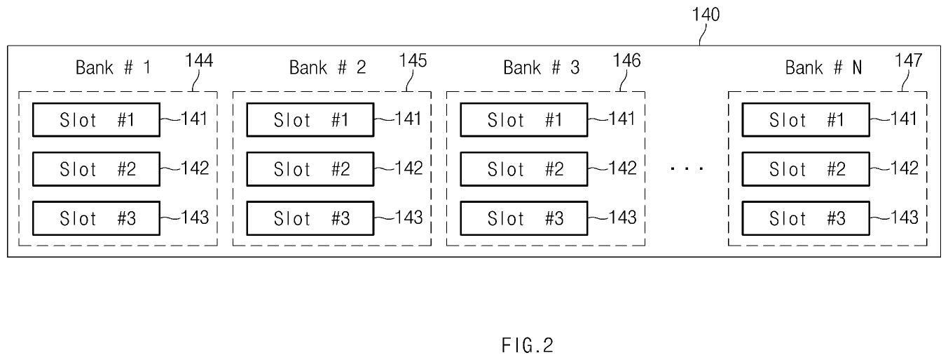

The storage 140 will be described in detail with reference to FIG. 2. FIG. 2 is a view illustrating a structure of the storage of the apparatus for determining the driving tendency of the driver according to an exemplary embodiment of the present disclosure. As shown in FIG. 2, the storage 140 according to an exemplary embodiment of the present disclosure may include one or more banks 144, 145, and 146 and one or more slots 141, 142, 143, which are arranged in each of the banks 144, 145, and 146. The slots 141, 142, and 143 may be configured to store the driving tendency of the driver determined according to the information regarding the occupant.

For example, a first slot 141 may be configured to store the driving tendency of the driver when no passenger (e.g., occupant) is detected within the vehicle. In addition, a second slot 142 may be configured to store the driving tendency of the driver when the passenger is an adult. Further, a third slot 143 may be configured to store the driving tendency of the driver when the passenger is a child. The storage 140 may include one or more banks 144, 145, and 146 in which one or more slots 141, 142, and 143 may be stored according to driver information.

Additionally example, a first bank 144 may be configured to store the driving tendency according to occupant information of a first driver. A second bank 145 may be configured to store the driving tendency according to occupant information of a second driver and a third bank 146 may be configured to store the driving tendency according to occupant information of an unidentified driver. When new driver information is identified, the storage 140 may be configured to allocate a new bank 147 and store a driving tendency determined with respect to the new driver.

The storage 140 may include at least one storage medium among a flash memory, a hard disc, a memory card, a read-only memory (ROM), a random access memory (RAM), an electrically erasable programmable read-only memory (EEPROM), a programmable read-only memory (PROM), a magnetic memory, a magnetic disc, or an optical disc.

Further, the controller 150 may be configured to execute an overall operation of the apparatus for determining the driving tendency of the driver according to an exemplary embodiment of the present disclosure. The controller 150 may also be configured to determine the driver information based on mobile terminal interlocking information provided from the communication device 110. The controller 150 may be configured to determine the driver information based on the driving posture setting information input by the input device 130 when the mobile terminal interlocking information is not provided from the communication device 110.

The controller 150 may further be configured to receive the driving information of the driver, obtained by the sensor 120, classify the driving information of the driver according to each driver information, and store the classified driving information of the driver in the storage 140. For example, the controller 150 may be configured to classify the driving information of the first driver and the driving information of the second driver and store the driving information classified according to the driver information in the storage 140.

The controller 150 may then be configured to determine the occupant information based on a signal output from the sensor 120. In particular, the controller 150 may be configured to determine whether the occupant or passenger seated on the seat is present based on the signal output from the SBR sensor. In response to determining that the occupant is present, the controller 150 may be configured to determine the weight of the occupant based on a voltage output from the ODS and determine whether the occupant is an adult or an infant/toddler based on the weight. The controller 150 may be configured to classify the driving information classified according to the driver information based on the occupant information and store the classified driving information in the storage 140.

For example, the controller 150 may be configured to classify the driving information when the driver is the first driver into the driving information when a passenger is not present in the vehicle, the driving information when the passenger is an adult, and the driving information when the passenger is a child and may be configured to store the classified driving information in the storage 140. The controller 150 may be configured to classify the driving information when the driver is the second driver into the driving information when a passenger is not present in the vehicle, the driving information when the passenger is an adult, and the driving information when the passenger is a child and may be configured to store the classified driving information in the storage 140.

According to an exemplary embodiment, the controller 150 may be configured to store the driving information of the first driver and the driving information of the second driver in different banks from each other and store the driving information classified according to the passenger information in the plural slots of each bank. The controller 150 may then be configured to learn the driving information classified according to the occupant or passenger information stored in each slot and determine the driving tendency of the driver based on the passenger information based on the learned result.

According to an exemplary embodiment, driving tendencies may be classified into an extra mild state, a mild state, a normal state, a sporty state, and an extra sporty state. For example, the controller 150 may be configured to determine that the driving tendency of the first driver is the extra sporty state based on the learned result of the driving information when the driver is the first driver and another passenger is not present in the vehicle.

In addition, the controller 150 may be configured to determine that the driving tendency of the first driver is the extra mild state based on the learned result of the driving information when the driver is the first driver and the passenger is an infant/toddler. Further, the controller 150 may be configured to determine that the driving tendency of the second driver is the normal state based on the learned result of the driving information when the driver is the second driver and the passenger is an adult.

Accordingly, the controller 150 may be configured to learn the driving information classified by the occupant or passenger of the same first driver to determine the driving tendency for each occupant, and thus the controller 150 may be configured to determine different driving tendencies from each other by each passenger for the same first driver. In addition, the controller 150 may be configured to learn driving tendencies classified by each driver for different drivers from each other and determine the different driving tendencies for the different drivers.

The controller 150 may further be configured to store the driving tendency of the driver according to the passenger information determined based on the learned result in each slot. The controller 150 may be configured to set the control value of the powertrain based on the driving tendency of the driver, determined according to the occupant information. For example, the controller 150 may be configured to determine that the driving tendency of the first driver is the extra sporty state based on the learned result of the driving information when the driver is the first driver and a passenger is not present in the vehicle and may be configured to set the control value of the powertrain based on the extra sporty state.

In addition, the controller 150 may be configured to determine that the driving tendency of the first driver is the extra mild state based on the learned result of the driving information when the driver is the first driver and the passenger is an infant/toddler (e.g., determined by detected weight) and may be configured to set the control value of the powertrain based on the extra mild state. The controller 150 may also be configured to determine that the driving tendency of the second driver is the normal state based on the learned result of the driving information when the driver is the second driver and the passenger is an adult and may be configured to set the control value of the powertrain based on the normal state. Accordingly, the controller 150 may be configured to adjust the driving of the vehicle by reflecting the driving tendency of the driver, which is changed depending on the passenger information. In other words, the vehicle may be operated differently based on the determined driving tendency of the particular driver.

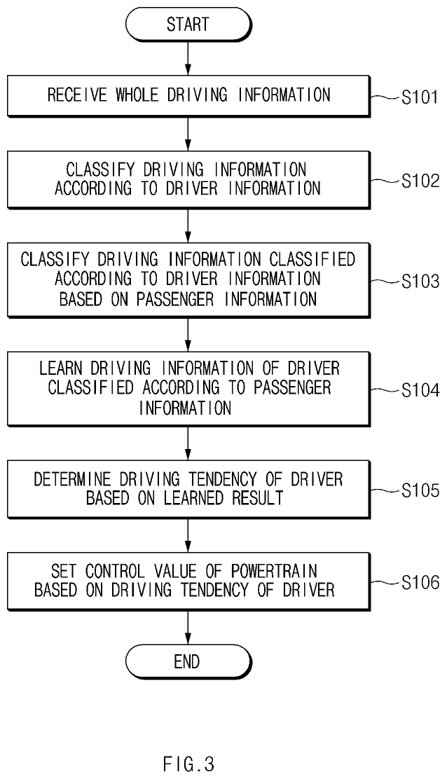

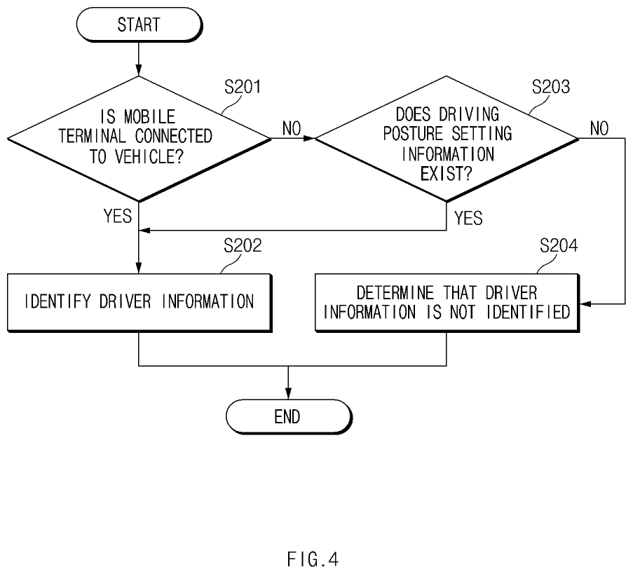

FIG. 3 is a flowchart illustrating a method for determining the driving tendency of the driver according to an exemplary embodiment of the present disclosure. Referring to FIG. 3, the controller 150 may be configured to receive the driving information of the driver obtained by the sensor 120 (S101). The controller 150 may be configured to receive the driving information obtained by the sensor 120 and classify the driving information of the driver according to the each driver information (S102). In operation S102, detailed descriptions on the driver information will be described with reference to FIG. 4.

In operation S102, the controller 150 may be configured to classify the driving information of the driver into the driving information of the first driver and the driving information of the second driver and store the driving information classified according to the driver information in the storage 140. According to an exemplary embodiment, in operation S102, the controller 150 may be configured to store the driving information of the first driver and the driving information of the second driver in different banks from each other.

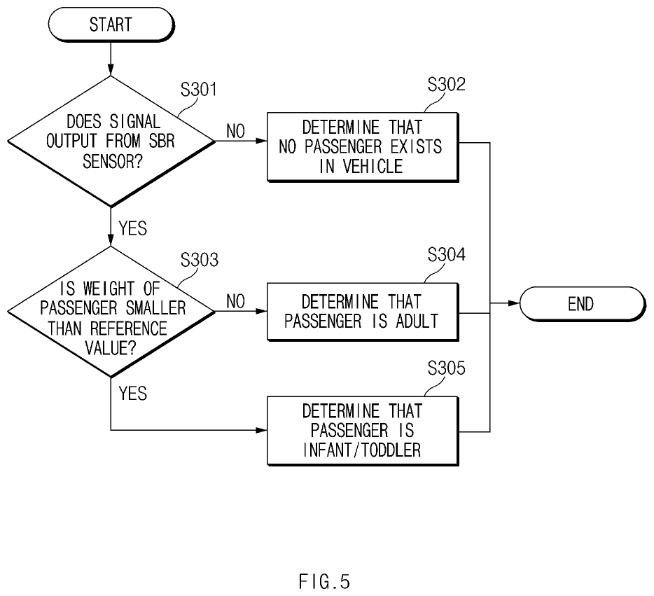

The controller 150 may also be configured to classify the driving information, which are classified according to the driver information in operation S102, based on the occupant information (S103). In operation S103, detailed descriptions on the occupant (e.g., passenger) information will be described with reference to FIG. 5. In operation S103, the controller 150 may be configured to store the driving information classified according to the occupant information in the storage 140. According to an exemplary embodiment, in operation S103, the controller 150 may be configured to store the driving information classified according to the occupant information in each of the slots of the bank.

The controller 150 may then be configured to learn the driving information of the driver, which are classified according to the occupant information (S104). The controller 150 may be configured to determine the driving tendency of the driver according to the occupant information based on the learned result in operation S104 (S105). For example, in operation S105, the controller 150 may be configured to determine that the driving tendency of the first driver is the extra sporty state based on the learned result of the driving information when the driver is the first driver and a passenger is not present or is not detected in the vehicle.

In addition, in operation S105, the controller 150 may be configured to determine that the driving tendency of the first driver is the extra mild state based on the learned result of the driving information when the driver is the first driver and the passenger is an infant/toddler. Further, in operation S105, the controller 150 may be configured to determine that the driving tendency of the second driver is the normal state based on the learned result of the driving information when the driver is the second driver and the passenger is an adult.

In operation S105, the controller 150 may be configured to store the driving tendency of the driver according to the occupant information determined based on the learned result in each slot. In operation S105, the controller 150 may be configured to set the control value of the powertrain based on the driving tendency of the driver, which is determined according to the occupant information (S106). For example, in operation S106, the controller 150 may be configured to determine that the driving tendency of the first driver is the extra sporty state based on the learned result of the driving information when the driver is the first driver and a passenger is not detected in the vehicle and may be configured to set the control value of the powertrain based on the extra sporty state.

In addition, in operation S106, the controller 150 may be configured to determine that the driving tendency of the first driver is the extra mild state based on the learned result of the driving information when the driver is the first driver and the passenger is an infant/toddler and set the control value of the powertrain based on the extra mild state. Further, in operation S106, the controller 150 may be configured to determine that the driving tendency of the second driver is the normal state based on the learned result of the driving information when the driver is the second driver and the passenger is an adult and set the control value of the powertrain based on the normal state.

FIG. 4 is a flowchart illustrating a method for determining the driver information according to an exemplary embodiment of the present disclosure. Referring to FIG. 4, the controller 150 may be configured to determine whether the vehicle is connected to the mobile terminal (S201). The controller 150 may further be configured to identify the driver information based on information regarding the mobile terminal connected to the vehicle in response to determining that the mobile terminal is connected to the vehicle (Y) (S202).

The controller 150 may be configured to determine whether the driving posture setting information input via the input device 130 exist in response to determining that the mobile terminal is not connected to the vehicle (N) (S203). The controller 150 may be configured to identify the driver information based on the driving posture setting information in response to determining that the driving posture setting information exist (Y) (S202). The controller 150 may be configured to determine that the driver information are not identified in response to determining that the driving posture setting information is not present (N) (S204).

FIG. 5 is a flowchart illustrating a method for determining the occupant information according to an exemplary embodiment of the present disclosure. Referring to FIG. 5, the controller 150 may be configured to determine whether the signal is output from the SBR sensor (S301). The controller 150 may be configured to detect the passenger in response to determining that the signal is output from the SBR sensor (Y). The controller 150 may be configured to detect that a passenger is not present in the vehicle in response to determining that the signal is not output from the SBR sensor (N)(5302).

Further, the controller 150 may be configured to determine whether the weight of the occupant is less than a reference value based on the voltage output from the ODS (S303) in response to detecting the passenger within the vehicle. The controller 150 may be configured to determine that the passenger is an infant/toddler (S305) in response to determining that the weight of the passenger is less than the reference value (Y). The controller 150 may also be configured to determine that the passenger is an adult (S304) in response to determining that the weight of the passenger is equal to or greater than the reference value (N).

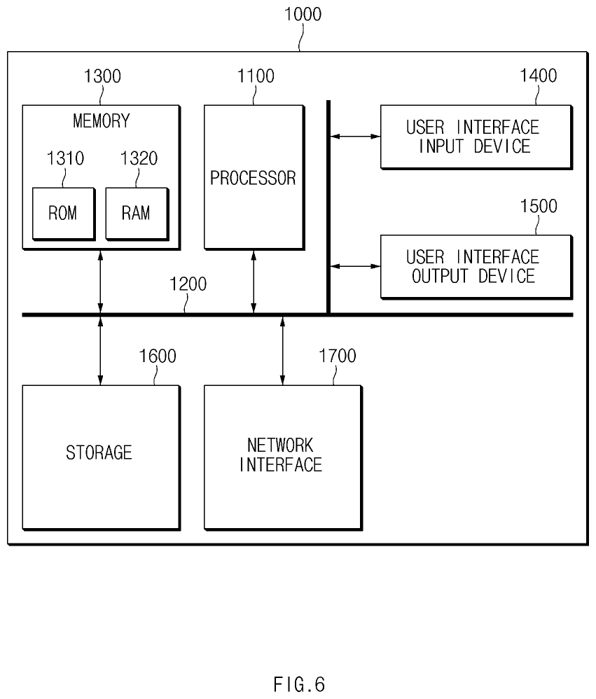

FIG. 6 is a block diagram illustrating a configuration of a computing system that executes a method for determining the driving tendency of the driver according to an exemplary embodiment of the present disclosure. Referring to FIG. 6, the computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the exemplary embodiments disclosed in the specification may be directly implemented with a hardware module, a software module, or combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The integrated processor and storage medium may reside in an application specific integrated circuit (ASIC). The ASIC may reside in a user terminal. Alternatively, the integrated processor and storage medium may reside as a separate component of the user terminal.

While the present invention has been described with reference to exemplary embodiments, it will be apparent to those skilled in the art that various changes and modifications may be made without departing from the spirit and scope of the present invention. Therefore, exemplary embodiments of the present invention are not limiting, but illustrative, and the spirit and scope of the present invention is not limited thereto. The spirit and scope of the present invention should be interpreted by the following claims, and it should be interpreted that all technical ideas which are equivalent to the present invention are included in the spirit and scope of the present invention.

What is claimed is:

1. An apparatus for determining a driving tendency of a driver, comprising:
a sensor configured to obtain driving information of the driver and to sense an occupant seated in a vehicle with the driver; and
a controller configured to determine occupant information based on the sensed information and determine the driving tendency of the driver corresponding to the occupant information based on the driving information of the driver.

2. The apparatus of claim 1, wherein the sensor configured to obtain the occupant information includes an occupant detection sensor (ODS) and a seat belt reminder signal (SBR) sensor.

3. The apparatus of claim 1, wherein the occupant information includes at least one selected from the group consisting of: information that no occupant is present in the vehicle, information that the occupant is an adult, and information that the occupant is an infant/toddler.

4. The apparatus of claim 1, wherein the controller is configured to classify the driving information of the driver according to driver information when different drivers exist.

5. The apparatus of claim 4, wherein the driver information is identified based on communication information with a mobile terminal or driving posture setting information.

6. The apparatus of claim 4, wherein the controller is configured to classify the driving information of the driver, wherein the driving information of the driver is classified according to the driver information of the different drivers, based on the occupant information.

7. The apparatus of claim 6, wherein the controller is configured to learn the driving information of the driver, wherein the driving information of the driver is classified according to the occupant information, and determine the driving tendency of the driver corresponding to the occupant information based on the learned result.

8. The apparatus of claim 1, further comprising a storage configured to store the driving information of the driver.

9. The apparatus of claim 8, wherein the storage includes:
one or more slots in which the driving tendency of the driver, which is determined according to the occupant information, is stored; and
a bank in which the one or more slots are stored after being classified according to the driver information.

10. The apparatus of claim 7, wherein the controller is configured to set a control value of a powertrain based on the determined driving tendency of the driver.

11. A method for determining a driving tendency of a driver, comprising:
receiving, by a controller, driving information of the driver;
identifying, by the controller, occupant information of an occupant seated in a vehicle with the driver; and
determining, by the controller, the driving tendency of the driver corresponding to the occupant information based on the driving information of the driver.

12. The method of claim 11, wherein the identifying of the occupant information is performed based on information obtained by an occupant detection sensor (ODS) or a seat belt reminder signal (SBR) sensor.

13. The method of claim 11, wherein the occupant information includes at least one selected from the group consisting of: information that no occupant exists in the vehicle, information that the occupant is an adult, and information that the occupant is an infant/toddler.

14. The method of claim 11, further comprising:
classifying, by the controller, the driving information of the driver according to driver information when different drivers from each other exist.

15. The method of claim 14, wherein the driver information is identified based on communication information with a mobile terminal or driving posture setting information.

16. The method of claim 14, further comprising:
classifying, by the controller, the driving information of the driver, wherein the driving information of the driver is classified according to the driver information of the different drivers, based on the occupant information.

17. The method of claim 16, wherein the determining of the driving tendency of the driver includes:
learning, by the controller, the driving information of the driver, wherein the driving information of the driver is classified according to the occupant information; and
determining, by the controller, the driving tendency of the driver corresponding to the occupant information based on the learned result.

18. The method of claim 17, further comprising:
setting, by the controller, a control value of a powertrain based on the determined driving tendency of the driver.
